(19) United States
(12) Patent Application Publication
(10) Pub. No.: US 2013/0207399 A1
(43) Pub. Date: Aug. 15, 2013

(54) Invention 30.8.10

(71) Applicant: Peter Robert Goodall, Hertfordshire (GB)

(72) Inventor: Peter Robert Goodall, Hertfordshire (GB)

(21) Appl. No.: 13/824,488

(22) PCT Filed: Aug. 26, 2011
(86) PCT No.: PCT/GB11/01271

§ 371 Date: Mar. 18, 2013

(51) Int. Cl. F03D 9/00; H02J 17/00

(52) U.S. Cl. CPC F03D 9/003; H02J 17/00
USPC 290/55; 307/151

(57) ABSTRACT

The invention is a wind energy conversion device that can use microwaves or electrical discharges to pass the electricity to another position

The invention is an apparatus that can be mounted internally or externally on a wind energy conversion apparatus filled with lighter than air gas as described UK Patent GB243481 or on or in a similar invention, where an apparatus rotates on itself to absorb substantially all of the wind assisted by fins or similar features that are designed to make contact with and catch the wind, thereby helping to maintain a desired position in the sky and where this apparatus is untethered and where this invention is the apparatus to direct microwaves carrying electrical currents that have being generated by the wind energy conversion apparatus to a desired position on the ground or to another device in the sky.

Various embodiments of the invention will use current and future methods to microwave electricity from one point to another and attach them internally or externally in a lighter than air structure that is untethered.

Further embodiments will similarly use current or future methods of turning electricity into microwaves so that they can be passed to another point and likewise attach the apparatus carrying out this function internally or externally to an untethered lighter than air structure.

The lighter than air structure described in the preceding two paragraphs may generate electricity as shown in the description, or in some embodiments will use the rotation of the structure on itself as shown, to maintain an approximate position of the lighter than air apparatus in the sky. Current and future technologies will make any necessary alternations to the flow of microwaves to another point to take into consideration any variation of the position of the lighter than air structure.

Various Apparatus to receive microwaved power will use current and future methods to receive the microwaved energy from the lighter than air structure or structures.

Future embodiments of the invention will make use as desired of methods that may be available to pass an electrical current from one position in the sky to another position and these may include electrical discharges similar to lightning and the receiving apparatus for such electrical discharges will make use as desired of current and future methods and technologies to receive such high voltages and pass them to a desired point.

Embodiments of the invention will be able to store as desired electricity that has being generated such as in batteries or in other ways that may be developed to store electricity and some embodiments will make use of electricity that has been generated to power the device itself. Other embodiments may make use of other means to provide power as desired and this may include solar power.

The microwave sending device for this invention 30.8.10 may be in a fixed in position inside or attached on the outside of the wind energy conversion apparatus or in some embodiments it may be a mechanism that through moving parts, is able to move it's position and the direction the device points within the lighter than air structure.

The Invention 30.8.10 may be on the outside of the device in some embodiments of the invention and this invention would be designed that if necessary it can move to point in the direction of the receiving apparatus which may be on the ground, or in the sky, or at sea or in some embodiments at points at very high altitudes or into space wherever it is desired that the microwaves should transfer the power they are carrying to another apparatus.

The receiving apparatus will be designed so as to be identified by the lighter than air apparatus to send the microwaves. The receiving apparatus will then be able to receive the microwaves and another apparatus connected to the receiving apparatus will then convert the microwaves back into electricity. The microwave sending device and the microwave receiving apparatus will be able to communicate with each other as necessary so that the microwaves can be sent and received as desired by the people operating the system. Commands can be sent by radio transmissions or other means of communication and encrypted as necessary. The devices would have the necessary computing power to carry out this function and would have fail safe systems should communication be lost so that the devices would cease sending microwaves and as necessary the wind energy generating systems would where it is safe slowly return to the ground.

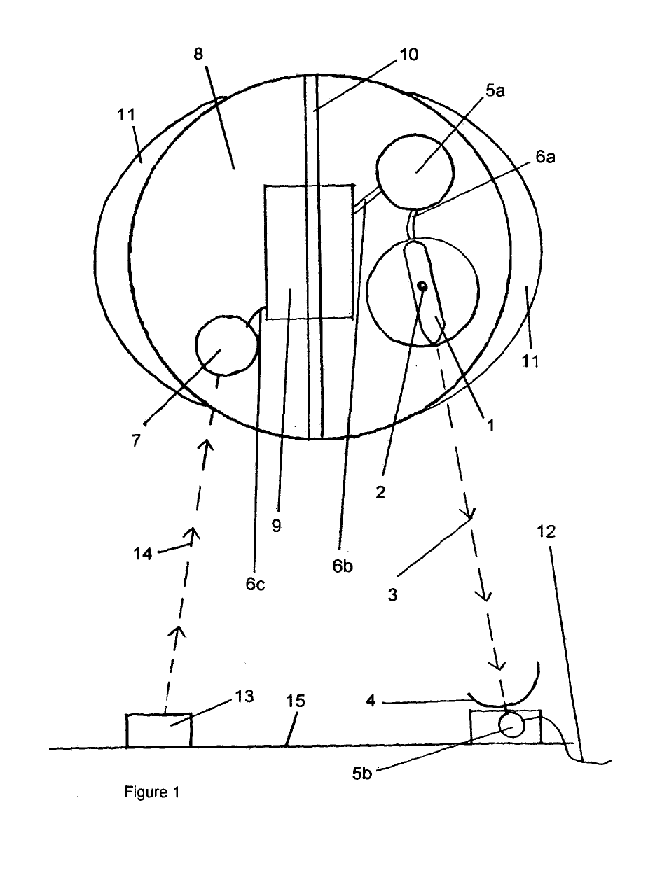

The device is shown in a series of drawings which are not to scale. The invention is shown in most detail in FIG. 1. Different embodiments of the device may be constructed in varying shapes and dimensions and be constructed of different materials while carrying out essentially the same function as described for this Invention.

In the drawings the following numbers represent these parts of the Invention

1 is the device that can transfer the microwaves to a desired point on the ground, on the water, in the air or in space according to different embodiments of the invention

In FIG. 1 the Invention is shown to have a part that is moveable that transfers the microwaves to a desired point and is marked as 1 but in some embodiments this feature may be fixed in position and in other embodiments may be attached to the outside of the wind conversion apparatus.

2 is the part on which the moveable part marked as 1 can rotate.

3 is the direction of the microwaves shown in FIG. 1 which is shown by a broken line as they are transferred to a different point and the arrow head attached to the broken line illustrates the path and direction of the microwaves.

4 is the top of the receiving apparatus receiving the microwaves

5a is the device in the wind conversion apparatus that converts the electricity into microwaves ready to be transferred by Part 1

5b is the device in the receiving apparatus that converts the microwaves back into electricity ready to be transferred to the local electricity grid, or used immediately or stored in batteries.

12 is the cable that takes the electricity to the local electricity grid

6a is the cable that takes the microwaves from part 5a to the part 1

6b is the cable that takes the generated electricity to the part 5a

6c is the cables that pass communications to other parts of the wind energy conversion apparatus. All parts of the apparatus will be wired to receive the communication though not all this wiring is shown in the drawing.

7 is the part of the wind energy communication device containing computers and communication equipment and other features necessary to operate the apparatus and relay and act on instructions from the person/s operating the apparatus

8 is the wind energy conversion apparatus. In some embodiments of the invention 8 will represent a device that contains some but not all of the features shown in FIG. 1 9 is the electrical generator that creates an electrical current as part 10 rotates as the wind energy conversion apparatus rotates as wind makes contact with the fins or similar features able to catch the wind and marked as 11.

There may be differing numbers of fins marked as 11 in different embodiments, two are shown in FIG. 1.

There may be a number of different parts of each feature shown in different embodiments as desired.

10 is the shaft that rotates inside the generator marked as 9 to create the electrical current. Part 9 is fixed in position and part 10 rotates inside it.

11 is the fin or feature on the wind energy conversion device that is designed to catch wind so that the energy from the wind will cause the device to rotate while absorbing some of the energy to help the device maintain its approximate position in the sky.

The position of the device is not critical to its operation as the ability to microwave the electricity to another point as desired gives the device more flexibility in where the device is positioned.

The invention will have the means through current technology to measure its position on a regular basis and adjust the direction that the microwaved energy has to travel to reach the desired point and to adjust the strength of the microwaved energy as desired depending on the conditions in the sky and at other points around the device such as around the device receiving the microwaved energy.

Other devices on the device itself or at other points and in other apparatus will measure atmospheric conditions or receive information on these conditions and the microwaved energy can be adjusted as necessary to meet changing conditions. Poor weather or changing air pressures for example may need the strength of the microwaved energy to be changed

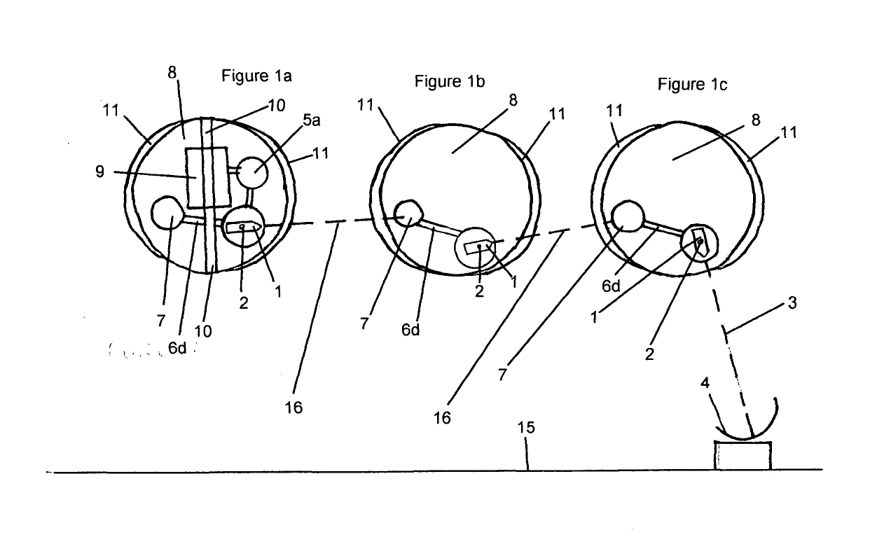

11a which is shown in FIG. 2 is an example of variations that may be made in the fin/s of some embodiments of the wind energy conversion apparatus that carries the invention and which may improve the stability of the rotation of the wind energy conversion apparatus as it rotates.

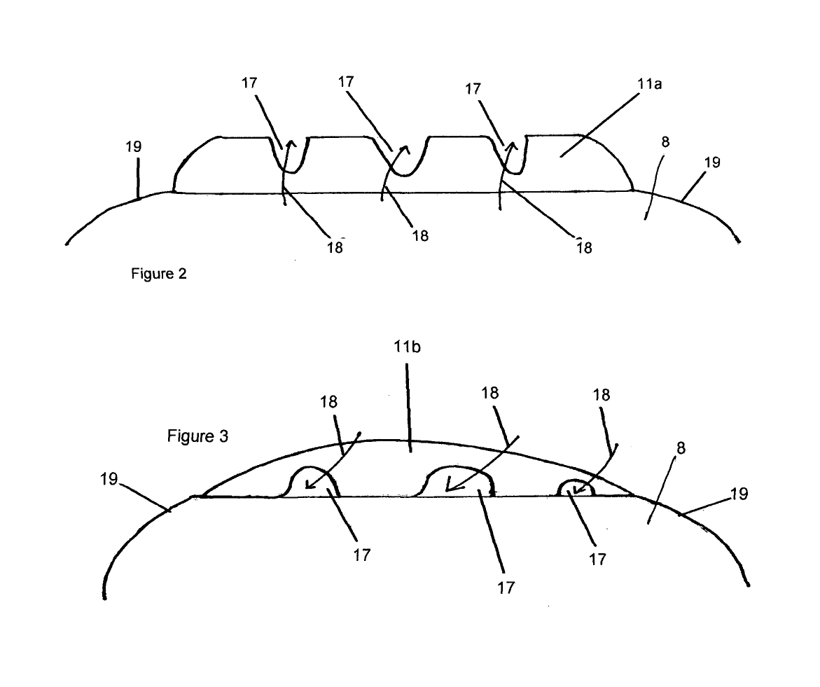

11b which is shown in FIG. 3 is another example of variations on the fin which may improve the stability of the rotation of the wind energy conversion device.

Different embodiments of the wind energy conversion apparatus may have different shaped fins on the same device and different embodiments may have varying numbers of fins.

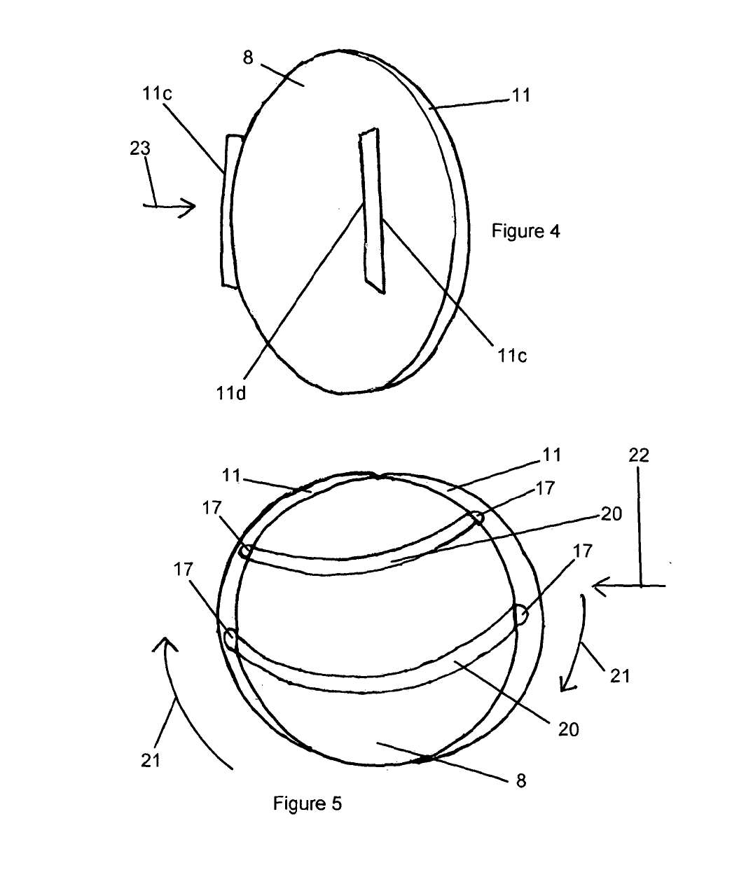

11c which is shown in FIG. 4 is a vertical feature on the wind energy conversion device in some embodiments that is not designed to catch wind as a fin is intended to do and which faces into the wind and this feature may assist the stability of the wind energy conversion device as it rotates.

11d is the point at which 11c is attached to the wind energy conversion apparatus

In some embodiments one design of part 11c shown in FIG. 4 may have indentations and varying shapes similar to those shown in parts 11a and 11b for the fins that help rotate the wind energy conversion device.

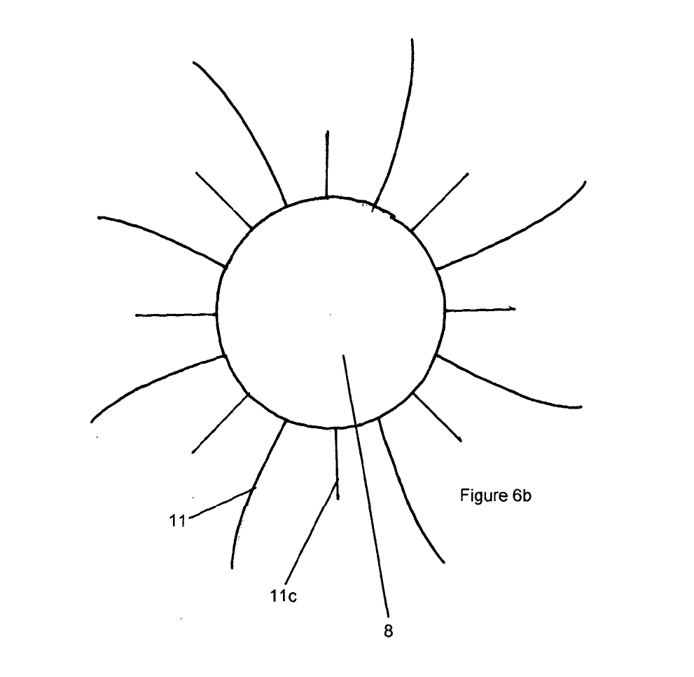

Part 11c is shown in FIG. 4 where short features attached to the surface of the wind energy conversion apparatus face into the direction of the wind are in an embodiment of the invention which also have fins in the embodiment shown and which are marked as 11. The fins may be positioned alternatively to parts 11c as in FIG. 6 and FIG. 6b. In other embodiments there may be various combinations of the two parts.

With parts 11a, 11b, 11c as with other parts of the invention various embodiments may be constructed with varying shapes, designs and materials as desired.

In some embodiments of the invention the part 11c may be of varying sizes and shapes.

12 represents the cables or other means to transfer the electricity to the power grid as desired from part 4.

13 is the device that sends instructions to part 7 by means such as radio waves to the wind energy conversion apparatus.

14 represents the path of the radio waves from part 13 and is represented by a broken line.

15 is the ground or in other embodiments may represent the sea or water if the wind energy conversion device/s are above sea or water.

16 is the path of the transfer of electricity in the form of microwaves to another airborne wind energy device. This is shown between FIGS. 1a, 1b and 1c.

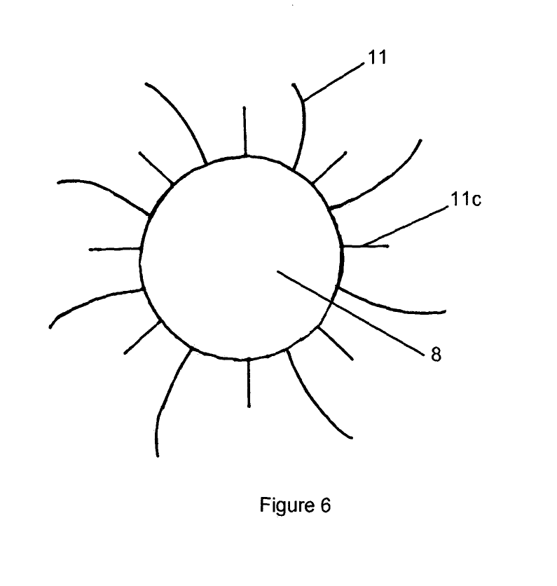

17 is the gap in the structure of a version of fin through which air can pass as one embodiment of 8 rotates and which is shown in FIG. 5.

18 is the direction the air through part 17 as one embodiment of 8 rotates in FIG. 2

19 is the surface of one embodiment of 8

20 is a feature attached to the outside of the device 8 that may resemble an aircraft wing in construction or in some embodiments may be flat on both sides and this is intended to help stabilise some embodiments of 8 as they rotate. This is shown in FIG. 5.

21 is the direction of this embodiment of 8 in FIG. 5 as it rotates

22 is the direction of the wind in FIG. 5

23 is the direction of the wind in FIG. 4

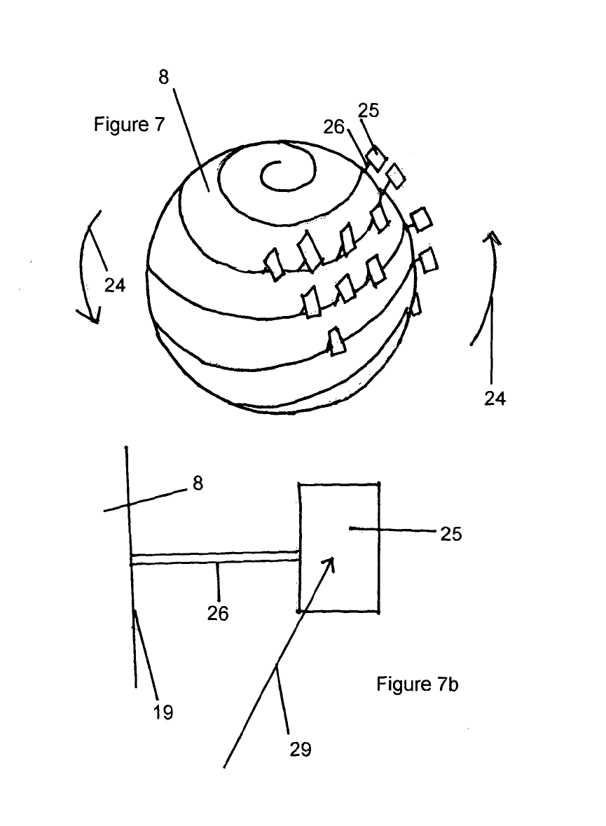

24 is the direction of the rotation of a version of 8 in FIG. 7

25 is the fin designed to catch wind on the version of 8 in FIG. 7

26 is a structure to attach the fin is 25 to 8 and this may be adjustable to allow the position and angle of the fin to be changed

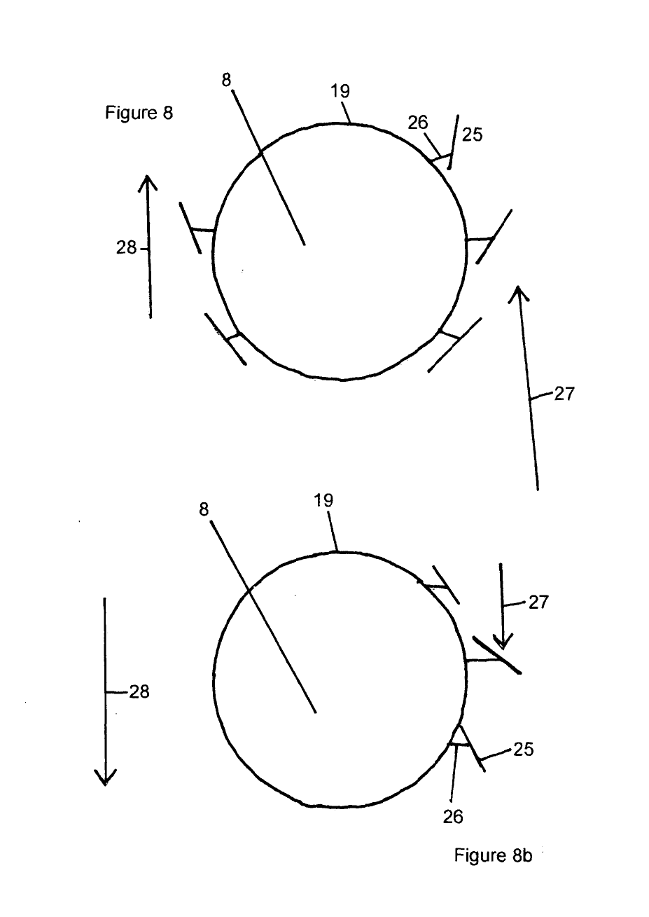

27 is the direction of the wind in FIGS. 8 and 8b

28 is the direction of the structure 8 in FIGS. 8 and 8b.

29 is the direction of the wind in FIG. 7b

Different embodiments of wind energy conversion devices may use the same means of rotation on a vertical axis to absorb wind energy to help maintain the position of the device in the sky, and some may have the means to also carry the means to generate electricity as shown by the device in FIG. 1 whereas other embodiments may only carry the means to transfer electricity around the sky and eventually to ground in the form of an alternative means to transfer electricity that is normally carried out by electricity pylons.

FIGS. 1a, 1b and 1c shows three airborne wind energy conversion devices that can move electricity from one point to another in the sky using the invention as shown in more detail in FIG. 1 and where the electricity is eventually transferred to the ground by the wind energy conversion devices marked as FIG. 1c. The electricity is generated by the wind energy conversion device shown as FIG. 1a, the electricity is transferred to FIG. 1b and then to FIG. 1c where the microwaved energy is transferred to the device on the ground marked as 4. Different embodiments of this may use different numbers of lighter than air structures as desired.

Transferring electricity through microwaves has being shown to be feasible by experiments such as the wireless Power Transmission (using microwaves) Experiment at Goldstone in California in 1975 This has being more recently demonstrated at Grand Bassin on Reunion Island' in 1997. In 2008 a long range transmission experiment successfully transmitted 20 watts 92 miles from a mountain on Maui to the main island of Hawaii.

The wind energy conversion apparatus rotates through fins or similar features catching the wind, this helps maintain the approximate desired position of the device through it is not critical to the work of the device, this drives a generator located within the device that generates electricity. Another feature of the wind energy conversion appartus converts the electricity into microwaves and this invention 30.8.10 allows the microwaves to carry the power that has been generated to desired points on the ground or to other lighter than air devices in other parts of the sky.

The wind energy conversion appartus is controlled by the person responsible for the device through radio transmissions or other means to communicate with the device, and this can vary the position of the device through the means described in Patent GB243481 or by attaching a device which utilises the wind to move a device in the sky to different positions as described in patent GB2445881.

In embodiments such as shown in FIGS. 1a, 1b and 1c the apparatus in the sky or the ground receiving the microwaves from a lighter than air structure/s will have the means to receive such microwaves from the wind energy conversion apparatus and convert the microwaves to electricity and transfer it to the desired local electrical power grid.

In some embodiments the function of the receiving apparatus on the ground or sky may also be carried out by ships or sea borne vessels that could convert the microwaves into electricity and pass the current to cables on the sea bed that could take the electricity to electrical grid systems on land, and even power ships or sea borne craft.

The electrical current converted from microwaves from wind energy conversion apparatus may also be stored in batteries or similar devices that can hold electrical charges or be used to create an action that can later generate electricity, similar to when bodies of water are pumped to a higher location to be released later to generate electricity.

In some embodiments of the invention the wind energy conversion apparatus will be have more than one device described in this Invention 30.8.10 which are either inside the device or attached to the outside of the device, and some embodiments may use a combination of both in the same apparatus and which can send microwaves to a desired point on the ground or sky, so that this embodiment of the invention can therefore pass the microwaves carrying the electrical power to more than one apparatus on the ground or in the sky, if necessary at the same time.

In some embodiments of the invention a series of devices that can absorb the wind through rotation can transfer microwaves from the device generating electricity described in Patent GB243481 from one device to another in relay, through the sky until it is desired that the microwaves should be passed to a device on the ground where the microwaves can be converted into electricity and these series of air borne devices would use embodiments of the Invention 30.8.10 where an apparatus can direct microwaves to a desired point. Such devices may have one or more apparatus to direct the microwaves to the desired location.

In some embodiments of the invention the fins or similar feature that catch the wind thereby causing the wind energy conversion apparatus to rotate may be of different lengths on the same device. In one embodiment a combination of fins where alternatively there is a shorter fin at right angles or at an angle approaching a right angle as in FIG. 4 and marked as 11c but which is not designed to catch the wind itself may add to the stability of the wind energy device when it is airborne.

It is to be understood that as new technologies develop they may be used in embodiments. An example would be the means to generate electricity and the means to transfer it to the ground. It is envisaged that new ways to achieve this will be developed in the future and as desired they may be incorporated into future embodiments of the device where the device which is airborne and untethered generates electricity, and this is then transferred to the ground also by means other than tethers, cables or forms of structure that connect the device physically to the ground.

An embodiment of the device will have the means through batteries or similar means to store the electricity generate until it is wished to discharge it to a desired point or back into the atmosphere.

One embodiment of the device may also release the electricity through electrical discharge similar to lightning and the device will have the equipment on the device to allow this to take place, and similarly equipment to receive these electrical discharges will be designed to withstand the huge forces involved and to be able to receive such electrical discharges and convert them into a manageable voltage that can be transferred to an electrical grid or used for some other purpose.

The devices will be designed with materials that are able to withstand the conditions and electrical currents that will be involved in the generation of electricity, conversion to microwaves or electrical discharges and the transference of this power to the ground or to a desired point elsewhere.

An embodiment of the device will have a fail safe system that should contact be lost with the operator of the device the device will cease transferring microwaves to the ground, and if necessary will discharge harmlessly any electrical energy it has generated into the atmosphere or elsewhere and through pre programmed instructions slowly travel to the ground or travel to an area perhaps over the sea where it will not cause a hazard to people or property.

Various embodiments of the wind energy conversion apparatus may use features similar to those used on aircraft or other airborne craft to help provide stability for the device as it rotates and when it is in the sky. Different embodiments may also use features such as similar to those on aircraft to alter the position or angle of the device as required. This would be operated through the receiving of instructions from the ground. Some embodiments of the invention may be unmanned and some may have crew on board. The parts similar to those in aircraft that may be used to assist the stability of some embodiments of 8 as they rotate and these parts may include wings and aerofoils in different embodiments of the invention.

FIG. 4 shows an embodiment of the wind energy conversion apparatus with a feature that faces into the wind and is marked as 11c.

FIG. 6 shows a view from overhead of the wind energy apparatus or embodiment of this invention which carries the invention. Not all parts 11 and 11c are marked to help with the clarity of the drawing.

FIG. 6b shows a view from overhead of another embodiment of the wind energy device or embodiment which carries this invention. Not all parts 11 and 11c are marked to help with the clarity of the drawing. In this version the fins marked as 11 and parts 11c are longer relative to the main body of the device marked as 8, compared to other embodiments such as the accompanying drawing FIG. 6.

The device marked as 8 may be of different sizes and shapes in different embodiments of the invention.

An embodiment of the wind energy conversion apparatus carrying the invention may have different designs.

One embodiment is shown in FIGS. 7 and 7b. This shows small fins marked as 25 that are attached to the device along a line that might be compared to the appearance of an apple that has being peeled with a knife. Not all the fins are marked to help with the clarity of the drawing. FIG. 7 shows some of the fins 25 as they may be placed on a version of 8. This embodiment may have more fins than are shown but fewer are shown or marked to help with clarity of the drawing. Different embodiments of this type of 8 might have more or fewer fins 25 attached.

The continuous line runs from bottom to top with small fins attached or devices that may catch wind. These fins may be attached or in further embodiments may be adjustable either collectively or separately or a combination of the two. If adjustable fins were instructed by those operating the lighter than air structure to point upwards as in FIG. 8b relative to the lighter than air structure the effect of the wind would be to push the lighter than air structure downwards. If the fins or similar features are pointed downwards as in FIG. 8 relative to the lighter than air structure this would push the lighter than air structure upwards and through both means further control might be possible over the lighter than air structure.

The fins pointed upwards are shown in FIG. 8b and the fins pointed downwards are shown in FIG. 8. Changing how much surface area of the fins and the direction they are pointing relative to the wind can affect the position of the lighter than air structure in the sky. If more fin is exposed to the wind greater force will be applied to the fin and hence the lighter than air structure and it would be possible to use different combinations of fins pointing in different directions, some with more surface area exposed to the wind, and others less the change the direction of the device in the sky.

In FIG. 8 for simplicity in the drawings the wind marked as 28 is heading upwards and in FIG. 8b the wind marked as 28 is heading downwards but wildly and rapidly directions of wind in the sky would enable enough variation in wind direction to allow those controlling the device to be move the device around the sky. To achieve this would require rapid exchanges of information between the devices measuring the local wind changes on different parts of its surface with those controlling the device, to allow rapid changes in direction of the fins to facilitate the movement of the lighter than air structure as desired. With sufficient computing power this should be possible and it is envisaged that the lighter than air structure would automatically change the fins to allow changes in direction within the sky as desired by those controlling the device.

If there is a quick gust of wind from a certain direction, quickly changing the position of the fins will allow the lighter than air structure carrying the invention to make use of this gust which may not last long to push or pull the structure into a different position. Using many changes in wind and changes in fin position will allow the lighter than air structure to move around the sky.

To achieve this such embodiments of the lighter than air structures carrying the invention would have instruments at various points of the structure to measure wind strength and direction, and would also be assisted by information as desired from other means to measure weather conditions such as satellites or other means used by meteorological offices.

Various embodiments of the lighter than air structure carrying the invention would have different arrays of fins in different positions on the structure and some may be fixed and some adjustable as desired.

In different embodiments of the lighter than air structure carrying the invention fins or similar features may be of different sizes and designs on the same structure as desired.

In a further embodiment of the lighter than air structure carrying the Invention the line running from bottom to top as previously described and shown in FIG. 7 may contain a groove in the surface of the lighter than air structure and no fins. This groove would contain features that would catch the wind and this would rotate the structure. Such an embodiment might be more robust than other embodiments shown such as with fins but would rotate less quickly than embodiments with fins and hence generate less electricity. However they may be more suitable in more challenging areas of the sky and possibly require less maintenance.

A further embodiment of the lighter than air structure or one that can also generate electricity as shown in FIG. 1 and carrying the Invention might be without fins but have a surface of the structure that has indentations or pockmarks that would give wind a grip on the structure with one part or side of each mark giving more resistance to the wind and constructed so that all the marks or indentations had a similar series of points on the same side where wind resistance was increased but which did not conflict with each other and this would cause the rotation of the lighter than air structure. It would also be robust but would rotate more slowly than structures with fins attached.

In one sense these marks on the structure would act in the same way as fins. Wind would make contact and this would rotate the lighter than air structure. The difference in appearance of these marks would be that they would be subtlety raised points or mounds in the groove around the lighter than air structure so that wind would make contact and rotate the lighter than air structure but in one version these marks or raised points within the groove would not be higher than the sides of the groove.

These lighter than air structures carrying the invention would be untethered. They would be free to roam around the sky microwaving the electricity they generate to points on the ground, at sea, at other points in the sky or into space, in different embodiments and as desired.

This idea of using the wind to change the position of a lighter than air structure in the sky is described more fully in Patents GB2445881 and GB2445880

Changing the temperature of the lighter than air gas supporting the structure as shown in Patent GB243841 would also help those controlling the structure to change its position in the sky. Chilling the temperature of the lighter than air gas would cause the device to lose altitude and increasing the temperature would allow the lighter than air structure to gain altitude. Embodiments of the lighter than air structure carrying the invention would include pieces of apparatus necessary to change the temperature of the lighter than air gas in the structure carrying the invention as desired.

It is to be understood that future embodiments of the invention may be built as desired using improvements in technology that may make the invention more efficient or cheaper to construct.

It is to be understood that any feature described in relation to any embodiment of the invention may be used in combination with any other embodiment of the invention.

1) The invention is an apparatus to direct microwaves carrying electrical currents that have being generated by a wind energy conversion apparatus from such an apparatus to a desired position on the ground or to another device in the sky and which can be mounted internally or externally on the untethered wind energy conversion device where an apparatus rotates on itself to absorb substantially all of the wind, assisted by fins or similar features that are designed to make contact with the wind, thereby helping to maintain a desired position in the sky, and where the rotation drives an electrical generator within the device.

2) A device according to claim 1 which can convert electricity to microwaves and where the apparatus to do this is carried internally within the device.

3) A device according to claim 1 where the apparatus to transfer microwaves to a desired point in the ground or sky is carried externally and fixed to the outside of the wind energy conversion apparatus.

4) A device with an apparatus according to claim 2 which is attached to the outside of the device in claim 1.

5) A device according to claim 1 with a series of other similar devices that can transfer electricity to a series of points in the sky until it is desired to relay the electricity to the ground or another point.

6) A device according to claim 1 which may have a number of features that face into the direction of the oncoming wind but which are not designed to catch wind as a fin by may add to the stability of the wind energy conversion apparatus as it rotates.

7) A device according to claim 6 where the fins or other features on the surface of the wind energy conversion device may have indentations or have variations in the shape of the fin as shown in FIGS. 2 and 3 of the drawing which may assist the stability of the wind energy conversion device as it rotates.

8) A device according to claim 7 which may have fins constructed of varying shapes.

9) A device according to claim 1 that can microwave electricity that has being generated by a lighter than air wind energy apparatus to a desired position in space.

10) A device according to claim 1 that can microwave electricity that has being generated by a lighter than air wind energy apparatus to a desired position on water.

11) A wind energy conversion apparatus filled with lighter than air gas where an apparatus rotates itself to absorb substantially all of the wind assisted by fins or similar features that are designed to make contact with and catch the wind, thereby helping to maintain a desired position in the sky and where this apparatus is untethered.

12) A device according to any of the claims that may also release the electricity through electrical discharge similar to lightning.

13) A device according to claim 12 that will have the equipment on the device to allow this to take place and similarly equipment to receive these electrical discharges that will be designed to withstand the huge forces involved and to be able to receive such electrical discharges and convert them into a manageable voltage that can be transferred to and electrical grid or used for some other purpose.

14) A device according to any of the claims that will have a fail safe system should contact be lost with the operator of the device so that the device will cease transferring microwaves to the ground and if necessary will discharge harmlessly any electrical energy it has generated into the atmosphere or elsewhere and through pre programmed instruction slowly travel to the ground or travel to an area perhaps over the sea where it will not cause a hazard to people or property.

15) A device according to any of the claims where its position is not critical to its operation as the ability to microwave the electricity to another point as desired gives the device more flexibility in where the device is positioned.

16) A device according to any of the claims which has a number of protruding features which can be adjusted to change the surface area and angle of the feature relative to the wind to affect the position of the lighter than air structure in the sky as shown in FIGS. 7,7b,8 and 8b.

17) A device according to any of the claims where the protruding features of the device that catch the wind which causes the device to rotate has open areas in the features through which the wind can pass and the resulting rapid movement of air can assist with the stability of the device and is shown by the features marked as 17 in FIGS. 2,3 and 5

18) A device according to any of the claims with an arrangement of protruding features or fins designed to catch the wind and cause the rotation of the device and where alternative fins are shorter and protrude in a straight line to help stabilise the device as it rotates and are marked as 11c and shown in FIGS. 6 and 6b

19) A device according to any of the claims that has in place of fins a surface that has indentations or pockmarks that would give wind a grip on the structure causing the device to rotate but where the device would therefore be more likely to be of a more robust and long lasting construction than one with fins protruding from the surface.
